(19) United States
(12) Patent Application Publication
(10) Pub. No.: US 2026/0179849 A1
(43) Pub. Date: Jun. 25, 2026

(54) MULTILAYER ELECTRONIC COMPONENT

(71) Applicant: SAMSUNG ELECTRO-MECHANICS CO., LTD., Suwon-si (KR)

(72) Inventors: Seung Yeon Lee, Suwon-si (KR); Seo Ho Lee, Suwon-si (KR); Berm Ha Cha, Suwon-si (KR)

(73) Assignee: SAMSUNG ELECTRO-MECHANICS CO., LTD., Suwon-si (KR)

(21) Appl. No.: 19/360,469

(22) Filed: Oct. 16, 2025

(30) Foreign Application Priority Data
Dec. 24, 2024 (KR) 10-2024-0195448

(51) Int. Cl. H01G 4/232; H01G 4/30

(52) U.S. Cl. CPC H01G 4/2325; H01G 4/30

(57) ABSTRACT

A multilayer electronic component according to an example embodiment of the present disclosure may include: a body including a dielectric layer, and an internal electrode alternately disposed with the dielectric layer; an external electrode disposed on the body and connected to the internal electrode; and an interfacial layer disposed between the body and the external electrode, and the interfacial layer may include an oxide including a conductive metal having a crystalline structure.

### CROSS-REFERENCE TO RELATED APPLICATION(S)

This application claims benefit of priority to Korean Patent Application No. 10-2024-0195448 filed on Dec. 24, 2024, in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-shaped capacitor mounted on a printed circuit boards of various types of electronic products such as video display devices including Liquid Crystal Displays (LCD) and Plasma Display Panels (PDP), computers, smartphones and mobile phones, and the circuits of the onboard charger (OBC) DC-DC converter of electric vehicles, and the like, and playing a role in charging or discharging electricity.

Currently, as electronic devices are miniaturized, miniaturization and high integration of a multilayer electronic component are also greatly required. Specifically, there have been various attempts to make a multilayer ceramic capacitor (MLCC), as a general-purpose electronic component, thinner and more capacitive.

As the MLCC becomes thinner and more capacitive, reliability problems of the multilayer electronic component frequently occur. The MLCC may generate heat in most operating environments, and when the heat is not effectively dissipated, the performance of the MLCC may deteriorate or a lifespan thereof may be shortened.

Specifically, in high-capacity and small MLCCs, the problem of heat generation may become more prominent due to the increase in current density.

Conventionally, as a method of efficiently dissipating heat from the MLCC, there have been attempts to use materials having high thermal conductivity in a material of a dielectric layer, or to change a structure of an internal electrode itself.

When using a material having high thermal conductivity as the material of the dielectric layer, because a separate ceramic additive should be added to the dielectric layer, a side effect of a decrease in an electrostatic capacity per unit volume may occur, and changing the structure of the internal electrode itself may not be suitable for mass production because this requires a change in shape, and it may be difficult to secure sufficient capacity per unit volume, and a problem of reduced reliability may occur due to structural changes in the internal electrode and the dielectric layer.

Accordingly, structural improvement of an MLCC that may suppress a decrease in reliability and a decrease in capacity while increasing the efficiency of heat dissipation is required.

### SUMMARY

An aspect of the present disclosure is to alleviate the problem of reduced heat dissipation performance due to a structural defect in an interface between the external electrode and the body.

An aspect of the present disclosure is to alleviate the problem of reduced bonding strength between a body and an external electrode when forming an interfacial layer at an interface between the external electrode and the body to improve heat dissipation performance.

However, the aspects of the present disclosure are not limited to the above-described contents, and may be more easily understood in the process of describing specific example embodiments of the present disclosure.

A multilayer electronic component according to an example embodiment of the present disclosure may include: a body including a dielectric layer, and internal electrodes alternately disposed with the dielectric layer; an external electrode disposed on the body and connected to the internal electrode; and an interfacial layer disposed between the body and the external electrodes, wherein the interfacial layer includes an oxide including a conductive metal having a crystalline structure.

An effect of the present disclosure is to provide a multilayer electronic component having excellent heat dissipation performance while suppressing heat emission.

An effect of the present disclosure is to provide a multilayer electronic component having excellent heat dissipation performance while also having excellent mechanical strength and ESR characteristics.

However, the various advantageous advantages and effects of the present disclosure are not limited to the above-described contents, and may be more easily understood in the process of explaining specific example embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 schematically illustrates a cross-sectional view taken along line I-I of FIG. 1;

FIG. 3 schematically illustrates a cross-sectional view taken along line II-II of FIG. 1;

FIG. 4 is a schematic diagram illustrating an enlarged view of region P of FIG. 2;

FIG. 5 is a schematic diagram illustrating an enlarged view of region Q of FIG. 4;

FIG. 6 is a schematic diagram illustrating a cross-sectional view corresponding to FIG. 2 in a multilayer electronic component according to an example embodiment;

FIG. 7 is a schematic diagram illustrating an enlarged view of region R of FIG. 6;

FIG. 8 is an exploded perspective view illustrating the configuration of a body according to an example embodiment; and

FIG. 9A and FIG. 9B are schematic diagrams illustrating a portion of a method of manufacturing a multilayer electronic component according to an example embodiment.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. Furthermore, the example embodiments disclosed herein are provided for those skilled in the art to more completely explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

In the drawings, a first direction may be defined as a direction in which first and second internal electrodes are alternately disposed with a dielectric layer interposed therebetween, or an X-direction, and among second and third directions, perpendicular to the first direction, the second direction may be defined as a Y-direction, and a third direction may be defined as a Z-direction.

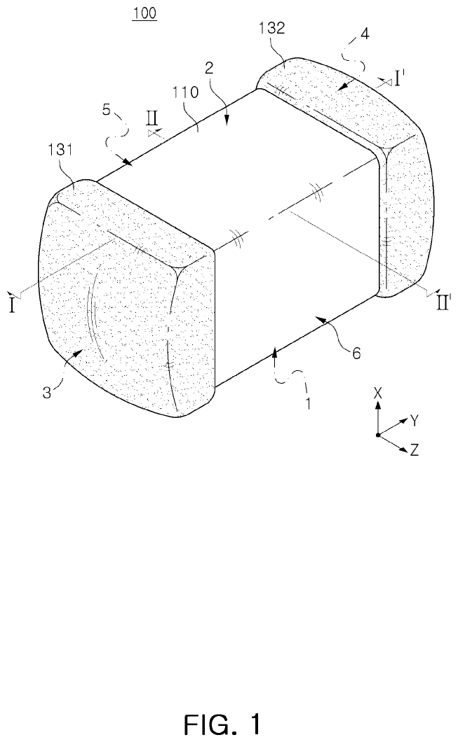

FIG. 1 is a schematic perspective view of a multilayer electronic component according to an example embodiment of the present disclosure.

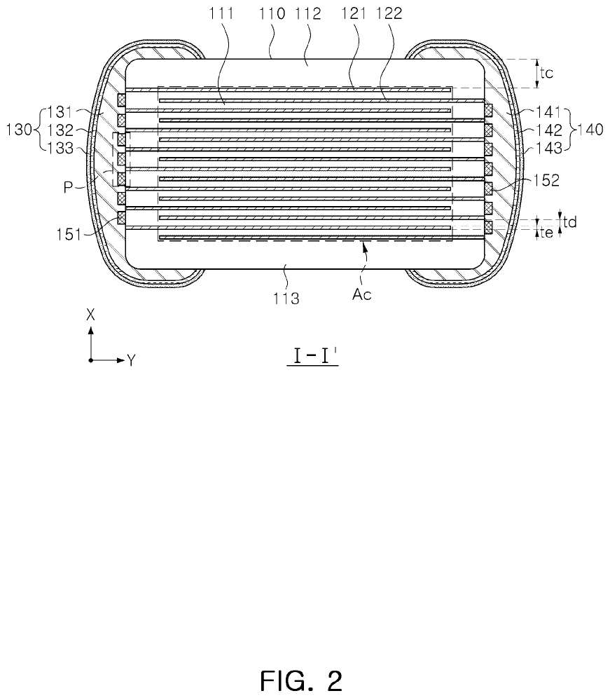

FIG. 2 schematically illustrates a cross-sectional view taken along line I-I of FIG. 1.

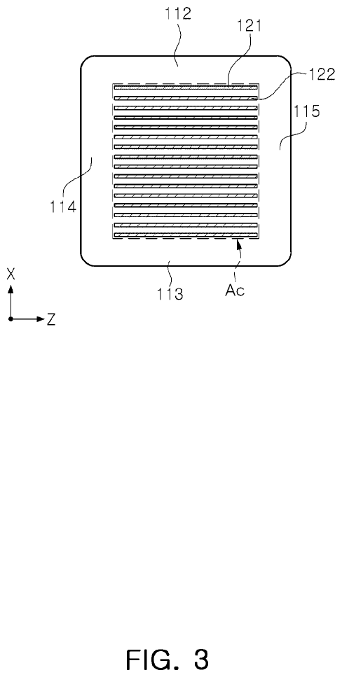

FIG. 3 schematically illustrates a cross-sectional view taken along line II-II of FIG. 1.

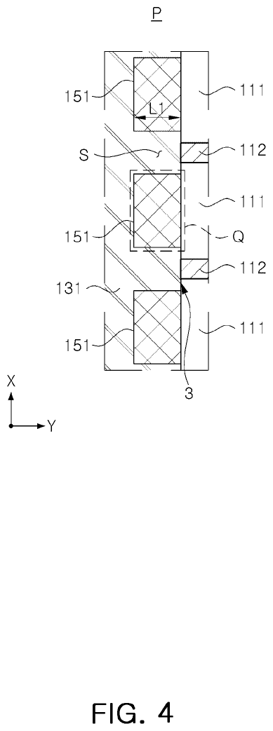

FIG. 4 is a schematic diagram illustrating an enlarged view of region P of FIG. 2.

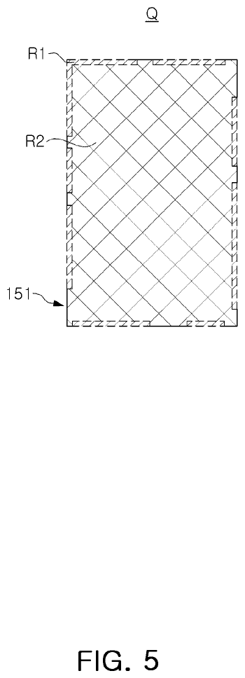

FIG. 5 is a schematic diagram illustrating an enlarged view of region Q of FIG. 4.

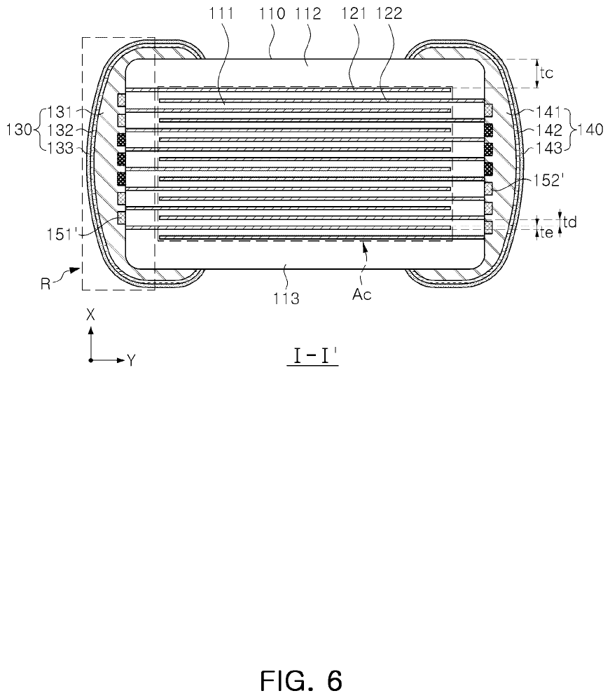

FIG. 6 is a schematic diagram illustrating a cross-sectional view corresponding to FIG. 2 in a multilayer electronic component according to an example embodiment.

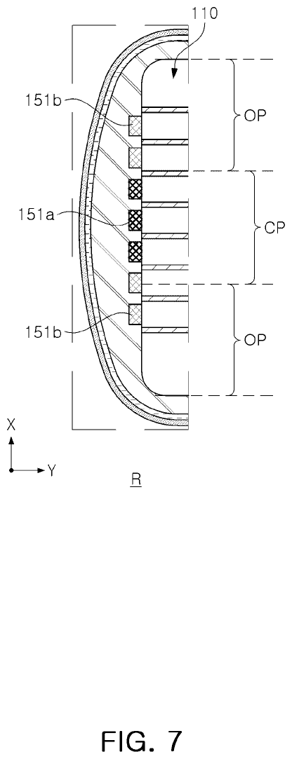

FIG. 7 is a schematic diagram illustrating an enlarged view of region R of FIG. 6.

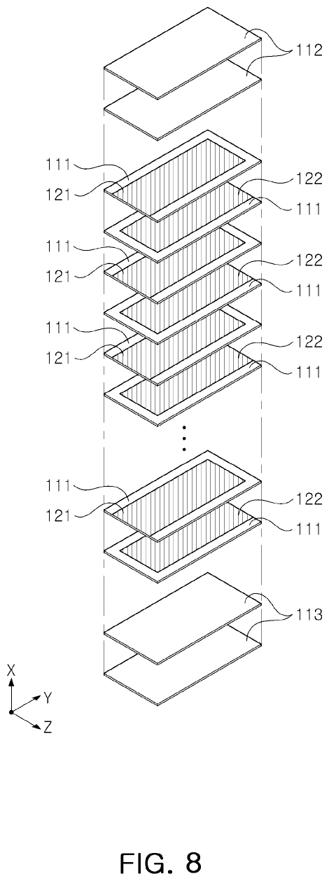

FIG. 8 is an exploded perspective view illustrating the configuration of a body according to an example embodiment.

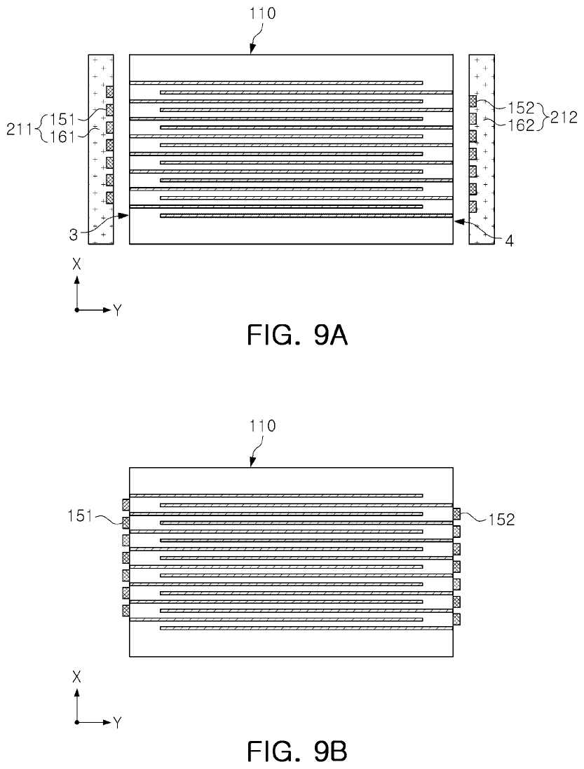

FIG. 9A and FIG. 9B are schematic diagrams illustrating a portion of a method of manufacturing a multilayer electronic component according to an example embodiment.

Hereinafter, referring to FIGS. 1 to 9B, a multilayer electronic component 100 according to an example embodiment of the present disclosure and various example embodiments thereof will be described in detail.

A multilayer electronic component 100 according to an example embodiment of the present disclosure may include a body 110 including a dielectric layer 111, internal electrodes 121 and 122 alternately disposed with the dielectric layer 111, external electrodes 130 and 140 disposed on the body 110 and connected to the internal electrodes 121 and 122, and interfacial layers 151 and 152 disposed between the body 110 and the external electrodes 130 and 140, and the interfacial layers 151 and 152 may include an oxide including a conductive metal having a crystalline structure.

Referring to FIG. 1, the multilayer electronic component 100 may include a body 110 and external electrodes 130 and 140 disposed on the body 110.

Referring to FIG. 2, the body 110 may have a form in which the dielectric layers 111 and the internal electrodes 121 and 122 are alternately disposed. Specifically, the body 110 may have a form in which first and second internal electrodes 121 and 122 are disposed alternately with the dielectric layers 111 interposed therebetween.

There is no particular limitation on a specific shape of the body 110, but as illustrated, the body 110 may be formed in a hexahedral or similar shape. Due to shrinkage of ceramic powder particles included in the body 110 during a sintering process, the body 110 may not have a perfectly square hexahedral shape, but may have a substantially hexahedral shape.

Referring to FIG. 1, the body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first and second surfaces 1 and 2 and connected to the third and fourth surfaces 3 and 4 and opposing each other in the third direction. In this case, the first direction may be defined as a direction in which the dielectric layers 111 and the internal electrodes 121 and 122 are alternately disposed.

The plurality of dielectric layers 111 forming the body 110 are in a sintered state, and boundaries between adjacent dielectric layers 111 may be integrated so as to be difficult to identify without using a scanning electron microscope (SEM).

A material included in the dielectric layer 111 is not particularly limited as long as sufficient electrostatic capacity may be obtained. For example, a barium titanate-based material, a lead composite perovskite-based material, or a strontium titanate-based material may be used. The barium titanate-based material may include BaTiO₃-based ceramic powder particles, and examples of the ceramic powder particles may include BaTiO₃, (Ba1-ₓCaₓ)TiO₃ (0<x<1), Ba(Ti1-_{y}Ca_{y})O₃ (0<y<1), (Ba1-ₓCaₓ)(Ti1-_{y}Zr_{y})O3 (0<x<1, 0<y<1), or Ba(Ti1-_{y}Zr_{y})O₃ (0<y<1), which is obtained by partially adopting Ca(calcium), Zr(zirconium), or the like.

Additionally, a material included in the dielectric layer 111 may be obtained by adding various ceramic additives, organic solvents, binders, dispersants, and the like, to powder such as barium titanate (BaTiO₃) according to the purpose of the present disclosure.

An average thickness td of the dielectric layer 111 is not particularly limited. In the case of miniaturization and high capacity of the multilayer electronic component 100, an average thickness td of the dielectric layer 111 may be 0.35 μm or less, and in order to improve the reliability of the multilayer electronic component 100 under high temperature and high voltage, an average thickness td of the dielectric layer 111 may be 5 μm or more.

The average thickness td of the dielectric layer 111 may refer to an average thickness of one or more dielectric layers, among a plurality of dielectric layers.

For example, the average thickness td of the dielectric layer 111 may be a value obtained by averaging the thicknesses measured at ¼, 2/4, and ¾ points when the dielectric layer is divided into four parts in a length direction, based on one layer of the dielectric layer adjacent to a point at which a longitudinal center line and a thickness direction center line of the capacitance formation portion meet, among the dielectric layer extracted from an image obtained by scanning first and second direction cross-sections cut from a central portion of the body 110 in the third direction, using a scanning electron microscope (SEM). When the measurement is expanded to upper two and lower two dielectric layers having equal intervals based on one layer of the dielectric layer adjacent to the point at which the longitudinal center line and the thickness direction center line of the capacitance formation portion meet, an average thickness of the dielectric layer may be further generalized.

Referring to FIGS. 2 and 3, the body 110 may include a capacitance formation portion Ac in which the first and second internal electrodes 121 and 122 overlap each other in the first direction, and cover portions 112 and 113 formed above and below the capacitance formation portion Ac in the first direction.

The cover portions 112 and 113 may include an upper cover portion 112 disposed on one surface of the capacitance formation portion Ac in the first direction, and a lower cover portion 113 disposed on the other surface of the capacitance formation portion Ac in the first direction.

Referring to FIG. 8, the cover portions 112 and 113 may be formed by stacking a single dielectric layer or two or more dielectric layers on upper and lower surfaces of the capacitance formation portion Ac in the thickness direction, respectively, and may basically play a role in preventing damage to the internal electrode due to physical or chemical stress.

The cover portions 112 and 113 does not include an internal electrode and may include the same material as the dielectric layer 111. That is, the cover portions 112 and 113 may include a ceramic material, for example, a barium titanate (BaTiO₃) ceramic material.

Meanwhile, an average thickness of the cover portions 112 and 113 does not need to be particularly limited. However, in order to more easily achieve miniaturization and high capacity of the multilayer electronic component, an average thickness tc of the cover portions 112 and 113 may be 15 μm or less.

An average thickness of the cover portions 112 and 113 may refer to a first direction size, and may be an average value of first direction sizes of the cover portions 112 and 113 measured at five points spaced apart from each other by equal intervals above or below the capacitance formation portion Ac.

Margin portions 114 and 115 may be disposed on one surface and the other surface of the capacitance formation portion Ac in the first direction.

The margin portions 114 and 115 may include a margin portion 114 disposed on the fifth surface 5 of the body 110 and a margin portion 115 disposed on the sixth surface 6. That is, the margin portions 114 and 115 may be regions in contact with both end surfaces of the body 110 in the third direction (e.g., a width direction).

As illustrated in FIG. 3, the margin portions 114 and 115 may refer a region between both ends of the first and second internal electrodes 121 and 122 and a boundary surface of the body 110 in a cross-section obtained by cutting the body 110 in a first direction-third direction (X-Z) direction.

The margin portions 114 and 115 may basically play a role in preventing damage to the internal electrode due to physical or chemical stress.

The margin portions 114 and 115 may be formed by forming the internal electrode by applying a conductive paste except for a region in which the margin portion is to be formed on a ceramic green sheet.

Additionally, in order to suppress a step portion caused by the internal electrodes 121 and 122, after the internal electrodes after stacking are cut to be exposed to the fifth and sixth surfaces 5 and 6 of the body, a single dielectric layer or two or more dielectric layers may be stacked on both side surfaces of the capacitance formation portion Ac in the third direction (Z-direction), thus forming the margin portions 114 and 115.

Meanwhile, a width of the margin portions 114 and 115 does not need to be particularly limited. However, in order to more easily achieve miniaturization and high capacity of the multilayer electronic component, an average width of the margin portions 114 and 115 may be 15 μm or less.

An average width of the margin portions 114 and 115 may refer to an average size of the margin portions 114 and 115 in the third direction, and may be an average value of third direction sizes of the margin portions 114 and 115 measured at five points spaced apart from each other by equal intervals on a side surface of the capacitance formation portion Ac.

The internal electrodes 121 and 122 may be disposed alternately with the dielectric layer 111 in the first direction.

The internal electrodes 121 and 122 may include first and second internal electrodes 121 and 122. The first and second internal electrodes 121 and 122 may be disposed alternately to face each other with the dielectric layer 111 forming the body 110 interposed therebetween, and may be connected to the third and fourth surfaces 3 and 4 of the body 110, respectively. Specifically, one end of the first internal electrode 121 may be connected to the third surface 3, and one end of the second internal electrode 122 may be connected to the fourth surface 4.

The first internal electrode 121 may be spaced apart from the fourth surface 4 and may be exposed through the third surface 3, and the second internal electrode 122 may be spaced apart from the third surface 3 and may be exposed through the fourth surface 4. The first external electrode 130 may be disposed on the third surface 3 of the body and connected to the first internal electrode 121, and a second external electrode 140 may be disposed on the fourth surface 4 of the body and connected to the second internal electrode 122.

That is, the first internal electrode 121 is not connected to the second external electrode 140 but is connected to the first external electrode 130, and the second internal electrode 122 is not connected to the first external electrode 130 but is connected to the second external electrode 140. Accordingly, the first internal electrodes 121 may be formed to be spaced apart from each other by a certain distance on the fourth surface 4, and the second internal electrodes 122 may be formed to be spaced apart from each other by a certain distance on the third surface 3. In this case, the first and second internal electrodes 121 and 122 may be electrically separated from each other by the dielectric layer 111 disposed in the middle thereof.

The body 110 may be formed by alternately stacking a ceramic green sheet on which the first internal electrode 121 is printed and a ceramic green sheet on which the second internal electrode 122 is printed, and then sintering the ceramic green sheets.

A material included in the internal electrodes 121 and 122 is not particularly limited, and a material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

Additionally, the internal electrodes 121 and 122 may be formed by printing a conductive paste for an internal electrode including one or more of nickel (Ni), copper (Cu), palladium (Pd), silver (Ag), gold (Au), platinum (Pt), tin (Sn), tungsten (W), titanium (Ti), and alloys thereof on a ceramic green sheet. A printing method of the conductive paste for an internal electrode may use a screen printing method or a gravure printing method, and the present disclosure is not limited thereto.

An average thickness te of the internal electrode is not separately limited. In the case of miniaturization and high capacity of the multilayer electronic component 100, the average thickness of the internal electrode may be 0.35 μm or less, and in the case of improving reliability of the multilayer electronic component 100 under high temperature and high voltage, the average thickness te of the internal electrode may be 1 μm or more.

The average thickness te of the internal electrodes 121 and 122 may refer to an average thickness of one or more internal electrodes, among the plurality of internal electrodes 121 and 122.

For example, the average thickness te of the internal electrodes 121 and 122 may be a value obtained by averaging the thicknesses measured at ¼, 2/4, and ¾ points at which the internal electrode is divided into four parts in the longitudinal direction, based on one layer of the internal electrode adjacent to the point at which the longitudinal center line and the thickness direction center line of the capacitance formation portion meet, among the internal electrode extracted from an image obtained by scanning the first and second direction cross-sections cut from the central portion of the body 110 in the third direction, using a scanning electron microscope (SEM). When the measurement is expanded to upper two and lower two internal electrodes having equal intervals based on one layer of the internal electrode adjacent to the point at which the longitudinal center line and the thickness direction center line of the capacitance formation portion meet, the average thickness of the internal electrodes may be further generalized.

The external electrodes 130 and 140 may be disposed on the third surface 3 and the fourth surface 4 of the body 110. The external electrodes 130 and 140 may include first and second external electrodes 130 and 140 disposed on the third and fourth surfaces 3 and 4 of the body 110, respectively, and connected to the first and second internal electrodes 121 and 122, respectively.

In an example embodiment, a structure in which a multilayer electronic component 100 has two external electrodes 130 and 140 is described, but the number or shape of the external electrodes 130 and 140 may be changed depending on the shape of the internal electrodes 121 and 122 or other purposes.

Meanwhile, the external electrodes 130 and 140 may be formed using any material that has electrical conductivity, such as metal, and a specific material may be determined in consideration of electrical characteristics, structural stability, or the like, and may further have a multilayer structure.

For example, the external electrodes 130 and 140 may include electrode layers 131 and 141 disposed on the body 110 and plating layers 132, 133, 142 and 143 formed on the electrode layers 131 and 141.

For a more specific example of the electrode layers 131 and 141, the electrode layer may be a sintered electrode including a conductive metal and glass, or a resin-based electrode including a conductive metal and resin.

Additionally, the electrode layers 131 and 141 may have a form in which the sintered electrode and the resin-based electrode are sequentially formed on the body. Additionally, the electrode layer may be formed by transferring a sheet including a conductive metal onto the body, or may be formed by transferring a sheet including a conductive metal onto the sintered electrode.

A material having excellent electrical conductivity may be used as the conductive metal included in the electrode layer, and is not particularly limited. For example, the conductive metal may be one or more of nickel (Ni), copper (Cu) and alloys thereof.

The plating layers 132, 133, 142 and 143 serve to improve the mounting characteristics. The type of the plating layers 132, 133, 142 and 143 is not particularly limited, and may be a plating layer including one or more of Ni, Sn, Pd and alloys thereof, and may be formed of a plurality of layers.

For more specific examples of the plating layers 132, 133, 142 and 143, the plating layer may be a Ni plating layer or an Sn plating layer, and may have a form in which the Ni plating layer and the Sn plating layer are sequentially formed on the electrode layer, and may have a form in which the Sn plating layer, the Ni plating layer and the Sn plating layer are sequentially formed. Additionally, the plating layer may include a plurality of Ni plating layers and/or a plurality of Sn plating layers.

The internal electrodes 121 and 122 and the dielectric layer 111 may be sources of heat generation during operation of the multilayer electronic component. Specifically, heat generation may occur due to the equivalent series resistance (ESR) of the multilayer electronic component, and heat generation may occur according to a loss factor (tanδ) of the dielectric layer 111.

When the heat generated inside the multilayer electronic component 100 is not efficiently released to the outside, not only may the multilayer electronic component itself be damaged, such as a decrease in reliability due to deterioration of the dielectric layer 111, a decrease in capacity per unit volume and a shortened lifespan, but also the performance of other components adjacent to the multilayer electronic component may be reduced.

The body 110 and the external electrodes 130 and 140 of the multilayer electronic component 100 may form pores or glass at an interface due to differences in sintering shrinkage and materials during the sintering process. When the pores or glass with low thermal conductivity is formed at the interface between the body 110 and the external electrodes 130 and 140, the heat generated inside the body 110 may not be effectively transferred and released to the external electrodes 130 and 140, which may cause a decrease in the heat dissipation performance of the multilayer electronic component 100.

Accordingly, the multilayer electronic component 100 according to an example embodiment of the present disclosure may include interfacial layers 151 and 152 disposed between the body 110 and the external electrodes 130 and 140, so that the heat generated inside the body 110 may be effectively released to the external electrodes 130 and 140 along the interfacial layers 151 and 152, thereby improving the heat dissipation performance of the multilayer electronic component 100.

The interfacial layers 151 and 152 according to an example embodiment of the present disclosure may include an oxide including a conductive metal, and the oxide including a conductive metal included in the interfacial layers 151 and 152 may have a crystalline structure.

During the sintering process of the multilayer electronic component 100, pores or amorphous glass may be formed at the interface between the body 110 and the external electrodes 130 and 140, and due to the low electrical conductivity of the pores or glass, the heat dissipation performance of the multilayer electronic component 100 may be reduced. According to an example embodiment of the present disclosure, since the interfacial layers 151 and 152 includes an oxide including a conductive metal having a crystalline nature, superior electrical conductivity may be secured as compared to a case in which the amorphous glass is formed at the interface between the body 110 and the external electrodes 130 and 140, thereby improving the heat dissipation characteristics of the multilayer electronic component 100.

Whether the oxide including the conductive metal included in the interfacial layers 151 and 152 has a crystalline structure may be confirmed by whether a distinct peak or diffraction pattern is obtained through X-ray diffraction analysis (XRD), electron diffraction pattern analysis (SAED, Selected Area Electron Diffraction), or the like, and various analysis techniques may be used.

Referring to FIG. 5, in an example embodiment, the interfacial layer 151 may be a composite layer including a first region R1 formed of an oxide including a conductive metal, and a second region R2 formed of a conductive metal. The first region R1 formed of an oxide including a conductive metal may serve to improve the bonding strength between the body 110 and the external electrodes 130 and 140, and the second region R2 formed of the conductive metal may serve to improve the heat dissipation efficiency. Accordingly, when the interfacial layer 151 includes the first region R1 formed of an oxide including a conductive metal, and the second region R2 formed of a conductive metal at the same time, as in an example embodiment, the bonding strength between the body 110 and the external electrodes 130 and 140 may be improved while simultaneously improving the heat dissipation efficiency.

Meanwhile, the oxide including the conductive metal included in the first region R1 may be an oxide including the conductive metal included in the second region R2.

The interfacial layers 151 and 152 may include an oxide including the conductive metal, but when the content of the oxygen element is excessive as compared to the content of the conductive metal element included in the interfacial layers 151 and 152, the heat release effect may be reduced, and when the content of the oxygen element is insufficient as compared to the content of the conductive metal element, the bonding strength between the body 110 and the external electrodes 130 and 140 may be reduced. Accordingly, in an example embodiment, a ratio of the content of the oxygen element to the content of the conductive metal element included in the interfacial layers 151 and 152 may be adjusted to 0.5 at % or more and 10 at % or less, the heat release effect and the bonding strength between the body 110 and the external electrodes 130 and 140 may be improved at the same time.

The oxide including the conductive metal included in the interfacial layers 151 and 152 may be an oxide including a conductive metal having excellent thermal conductivity, and examples of the conductive metal having excellent thermal conductivity may include silver (Ag), aluminum (Al), and copper (Cu). That is, in an example embodiment, the conductive metal may include one or more of silver (Ag), aluminum (Al), and copper (Cu), and the oxide including the conductive metal included in the interfacial layers 151 and 152 may be an oxide including one or more of gold (Au), silver (Ag) and copper (Cu).

A method of confirming the composition of the interfacial layers 151 and 152 are not particularly limited. For example, in the first and second direction cross-sections polished to a center of the multilayer electronic component 100 in the third direction, a specific area of the interface between the body 110 and the external electrodes 130 and 140 may be analyzed by Scanning Electron Microscope-Energy Dispersive X-ray Spectroscopy (SEM-EDX) to confirm the presence and concentration (at %) of conductive metal elements and oxygen elements. Accordingly, M1 and M2 may be determined. Other methods and/or tools appreciated by one of ordinary skill in the art, even if not described in the present disclosure, may also be used.

Meanwhile, the interfacial layers 151 and 152 analyzed by the SEM-EDX may be divided into a region in which the oxygen concentration is less than 0.5 at % and a region in which the oxygen concentration is 0.5 at % or more, and the region in which the oxygen concentration is less than 0.5 at % may be defined as a region formed substantially of conductive metal, and the region in which the oxygen concentration is 0.5 at % or more may be defined as a region formed substantially of oxides including conductive metal.

The interfacial layers 151 and 152 may be in contact with the third surface 3 or the fourth surface 4 of the body 110. Specifically, the first interfacial layer 151 may be in contact with the third surface 3 of the body 110, and the second interfacial layer 152 may be in contact with the fourth surface 4 of the body 110. Since the third surface 3 of the body 110 is a surface in contact with the first internal electrode 121 and the fourth surface 4 of the body 110 is a surface in contact with the second internal electrode 122, the third surface 3 and the fourth surface 4 of the body 110 may be main dissipation paths of heat generated inside the body 110. According to an example embodiment, since the interfacial layers 151 and 152 are disposed to be in contact with the third surface 3 or the fourth surface 4 of the body 110, which is the main dissipation path of heat generated inside the body 110, the heat dissipation characteristics of the multilayer electronic component 100 may be further improved.

Since the interfacial layers 151 and 152 includes an oxide including a conductive metal, when the interfacial layers 151 and 152 are in contact with the internal electrodes 121 and 122, the electrical connectivity between the internal electrodes 121 and 122 and the external electrodes 130 and 140 may be reduced. Accordingly, in an example embodiment, the interfacial layers 151 and 152 may be spaced apart from the internal electrodes 121 and 122, so that the phenomenon of the electrical connectivity between the internal electrodes 121 and 122 and the external electrode 130 and 140 may be prevented from being deteriorated.

In the process of coupling the body 110 and the external electrode 130 and 140 through sintering, pores or amorphous glass may be formed at the interface between the dielectric layer 111 of the body 110 and the external electrode 130 and 140. In this case, the heat dissipated from the dielectric layer 111 to the external electrodes 130 and 140 may be absorbed by the pores or amorphous glass at the interface between the dielectric layer 111 and the external electrodes 130 and 140, and thus the heat dissipation efficiency of the multilayer electronic component 100 may be reduced. Accordingly, in an example embodiment, since the interfacial layers 151 and 152 are disposed to be in contact with the dielectric layer 111, the formation of the pores or amorphous glass at the interface between the dielectric layer 111 and the external electrodes 130 and 140 may be prevented, thereby further improving the heat dissipation characteristics of the multilayer electronic component 100.

In an example embodiment, the interfacial layers 151 and 152 may be disposed in plural on the third surface 3 or the fourth surface 4.

Specifically, referring to FIG. 2, the first interfacial layer 151 may be disposed in plural on the third surface 3, and the second interfacial layers 152 may be disposed in plural on the fourth surface 4. In this case, a plurality of first interfacial layers 151 may be spaced apart from each other in the first direction, a direction in which the dielectric layer 111 and the internal electrodes 121 and 122 are alternately disposed, and the second interfacial layers 152 may also be spaced apart from each other in the first direction. Accordingly, unevenness may be formed at the interface between the body 110 and the external electrodes 130 and 140, thereby improving the mechanical strength of the bond between the body 110 and the external electrodes 130 and 140.

Referring to FIG. 4, in order to further improve the mechanical strength of the bonding between the body 110 and the external electrodes 130 and 140, the electrode layers 131 and 142 as components of the external electrodes 130 and 140, may be preferably disposed in a space S in which the plurality of interfacial layers 151 and 152 are spaced apart from each other. That is, in an example embodiment, a portion of the external electrode may be disposed in the space S in which the plurality of interfacial layers 151 and 152 are spaced apart from each other in the first direction.

Formation lengths of the interfacial layers 151 and 152 may be adjusted in consideration of a degree of heat dissipation effect and formation thicknesses of the external electrodes 130 and 140. Specifically, a maximum length of the interfacial layers 151 and 152 may be 0.10 μm or more and 7.00 μm or less.

Referring to FIG. 4, a maximum length of the interfacial layer 151 may be indicated as L1, and may denote a maximum length in the first direction measured from any interfacial layer of the first and second direction cross sections polished to the center of the multilayer electronic component 100 in the third direction. A scanning electron microscope may be used to measure the maximum length. Other methods and/or tools appreciated by one of ordinary skill in the art, even if not described in the present disclosure, may also be used.

When a maximum length L1 of the interfacial layers 151 and 152 are less than 0.10 μm, the effect of heat dissipation may be insufficient, and the formation of pores or glass at the interface between the body 110 and the external electrodes 130 and 140 may not be prevented. When the maximum length L1 of the interfacial layers 151 and 152 exceeds 7.00 μm, as a result of insufficient space for the external electrode including the conductive metal to be formed, the effect of heat dissipation may be reduced.

Referring to FIG. 6, interfacial layers 151′ and 152′ according to an example embodiment may have different ratios of the content of copper (Cu) elements relative to the content of oxygen (O) elements depending on the position thereof.

Referring to FIG. 7, when the body 110 according to an example embodiment is divided into three parts in the X-direction, a direction in which the dielectric layers and internal electrodes are alternately disposed, the body 110 may be divided into a central portion CP disposed in the center disposed and outer portions OP disposed in an upper portion and a lower portion of the central portion. In this case, the interfacial layer 151′ may include a first interfacial layer 151a in contact with the central portion CP and a second interfacial layer 151b in contact with the outer portion OP.

Meanwhile, since the amount of heat generated inside the body 110 may reach a maximum in the central portion CP having a high current density, in order to significantly improve the heat dissipation characteristics of the multilayer electronic component 100, it may be necessary to efficiently release the heat generated in the central portion CP.

Accordingly, in an example embodiment, when a ratio of the content (at %) of the conductive metal element to the content (at %) of the oxygen (O) element included in the first interfacial layer 151a is defined as M1, and a ratio of the content (at) of the conductive metal element to the content (at %) of the oxygen (O) element included in the second interfacial layer 151b is defined as M2, M1>M2 may be satisfied. Accordingly, the heat generated intensively in the central portion CP may be efficiently dissipated along the first interfacial layer 151a having a relatively high ratio of the content of the conductive metal element to the content of the oxygen (O) element, and since the second interfacial layer 151b having a relatively low ratio of the content of the conductive metal element to the content of the oxygen (O) element is disposed in the outer portion OP, bonding strength between the body 110 and the external electrodes 130 and 140 may be improved.

In an example embodiment, the ratio of M1 to M2 (M1/M2) may exceed 1, but more preferably may be 2 or more, and accordingly, the heat dissipation effect of the present disclosure and the bonding strength enhancement effect between the body 110 and the external electrodes 130 and 140 may be further improved.

Meanwhile, an upper limit of the ratio of M1 to M2 (M1/M2) is not particularly limited, and may vary depending on the type of conductive metal and oxide including the conductive metal, and for example, M1/M2 may be 4 or less.

A method of forming the interfacial layers 151 and 152 according to the present disclosure is not particularly limited. Referring to FIG. 9A, pattern sheets 211 and 212 may be disposed on the third surface 3 and the fourth surface 4 of the body 110. The pattern sheets 211 and 212 may include the interfacial layers 151 and 152 and side dielectric layers 161 and 162, and the interfacial layers 151 and 152 and the side dielectric layers 161 and 162 may be in a state of a conductive paste and a ceramic sheet before sintering.

Referring to FIG. 9B, the side dielectric layers 161 and 162 of the pattern sheets 211 and 212 may be removed through a separate process, and thus only the interfacial layers 151 and 152 may exist on the third surface 3 and the fourth surface 4 of the body 110. In this case, a method of removing the side dielectric layers 161 and 162 is not particularly limited. For example, the side dielectric layers 161 and 162 may be removed by chemical etching using an acidic solution or the like, or physical etching using a high-energy plasma or laser. Meanwhile, the etching area may be controlled through mask patterning in order to remove the side dielectric layers 161 and 162 more efficiently, and the etching may be applied similarly even when the pattern sheet is formed of a conductive metal and a separate dielectric layer is not formed.

Although not illustrated in the drawing, thereafter, a process of forming the external electrodes 130 and 140 and a process of sintering the body 110 and the external electrodes 130 and 140 may be performed on the third surface 3 and the fourth surface 4 of the body 110.

A composition of the interfacial layers 151 and 152 according to an example embodiment of the present disclosure and various example embodiments thereof may be controlled by a method of controlling the composition of the conductive paste included in the pattern sheet 211 and 212 or controlling a sintering atmosphere of the body 110 and the external electrodes 130 and 140. Additionally, the structure or pattern of the interfacial layers 151 and 152 may be formed by a method of controlling a position or arrangement of the conductive paste disposed in the pattern sheet 211 and 212.

Although an example embodiment of the present disclosure has been described in detail above, the present disclosure is not limited to the above-described embodiments and the accompanying drawings but is defined by the appended claims. Therefore, those of ordinary skill in the art may make various replacements, modifications, or changes without departing from the technical concept of the present disclosure defined by the appended claims, and these replacements, modifications, or changes should be construed as being included in the technical concept of the present disclosure.

Additionally, the expression ‘an example embodiment’ used in the present disclosure does not mean the same embodiment, and is provided to emphasize and explain different unique characteristics. However, the example embodiments presented above do not preclude being implemented in combination with the features of another embodiment. For example, although items described in a specific example embodiment are not described in another example embodiment, the items may be understood as a description related to another example embodiment unless a description opposite or contradictory to the items is in another example embodiment.

In the present disclosure, the terms are merely used to describe a specific example embodiment, and are not intended to limit the present disclosure. Singular forms may include plural forms as well unless the context clearly indicates otherwise.

What is claimed is:

1. A multilayer electronic component, comprising:
a body including a dielectric layer, and internal electrodes alternately disposed with the dielectric layer;
an external electrode disposed on the body and connected to the internal electrodes; and
an interfacial layer disposed between the body and the external electrode,
wherein the interfacial layer includes an oxide including a conductive metal having a crystalline structure.

2. The multilayer electronic component according to claim 1, wherein the interfacial layer includes:
a first region that includes the oxide, and
a second region that includes the conductive metal.

3. The multilayer electronic component according to claim 1, wherein a ratio of a content of an oxygen element to a content of a conductive metal element included in the interfacial layer is 0.5 at % or more and 10 at % or less.

4. The multilayer electronic component according to claim 1, wherein the conductive metal includes at least one of silver (Ag), aluminum (Al) or copper (Cu).

5. The multilayer electronic component according to claim 1, wherein the internal electrodes include a first internal electrode and a second internal electrode,
the external electrode includes a first external electrode connected to the first internal electrode, and a second external electrode spaced apart from the first external electrode and connected to the second internal electrode,
the body includes a first surface and a second surface opposing each other in a first direction, a direction in which the dielectric layer and the internal electrodes are alternately disposed, a third surface and a fourth surface opposing each other in a second direction in which the first external electrode and the second external electrode are spaced apart from each other, a fifth surface and a sixth surface opposing each other in a third direction that is perpendicular to the first direction and the second direction, and
the interfacial layer is in contact with the third surface, the fourth surface, or both the third surface and the fourth surface.

6. The multilayer electronic component according to claim 1, wherein the interfacial layer is spaced apart from the internal electrodes.

7. The multilayer electronic component according to claim 1, wherein the interfacial layer is in contact with the dielectric layer.

8. The multilayer electronic component according to claim 1, wherein the interfacial layer includes a plurality of interfacial layers, and
the interfacial layer is disposed in a direction in which the dielectric layer and the internal electrodes are alternately disposed.

9. The multilayer electronic component according to claim 8, wherein a portion of the external electrode is disposed in a space in which adjacent interfacial layers among the plurality of interfacial layers are spaced apart from each other.

10. The multilayer electronic component according to claim 1, wherein the interfacial layer has a maximum length of 0.10 μm or more and 7.00 μm or less.

11. The multilayer electronic component according to claim 1, wherein in a direction in which the dielectric layer and the internal electrodes are alternately disposed, the body includes a central portion disposed in a center of the body, and an outer portion disposed on opposing surfaces of the central portion in the direction in which the dielectric layer and the internal electrodes are alternately disposed,
when a ratio of a content (at %) of a conductive metal element to a content (at %) of an oxygen (O) element included in the interfacial layer in contact with the central portion is referred to as M1, and a ratio of a content (at %) of the conductive metal element to the content (at %) of the oxygen (O) element included in the interfacial layer in contact with the outer portion is defined as M2,
M1/M2 satisfies more than 1.

12. The multilayer electronic component according to claim 11, wherein M1/M2 satisfies 2 or more and 4 or less.
